(19) United States
(12) Patent Application Publication
(10) Pub. No.: US 2015/0172429 A1
(43) Pub. Date: Jun. 18, 2015

(54) DATA TRANSMISSION DEVICE AND DATA TRANSMISSION SYSTEM

(71) Applicant: HUAWEI DEVICE CO., LTD., Shenzhen (CN)

(72) Inventors: Xupeng CAI, Shenzhen (CN); Huizhong LIN, Shenzhen (CN)

(73) Assignee: HUAWEI DEVICE CO., LTD., Shenzhen (CN)

(21) Appl. No.: 14/586,283

(22) Filed: Dec. 30, 2014

Related U.S. Application Data
(63) Continuation of application No. PCT/CN2013/089385, filed on Dec. 13, 2013.

(51) Int. Cl. H04M 1/02; H04W 4/00

(52) U.S. Cl. CPC H04M 1/0258; H04W 4/008

(57) ABSTRACT

The present invention disclose a data transmission device and a data transmission system. When a user needs to use the body part to establish a Bluetooth communication connection with the terminal device, the user may remove the body part and put it in an ear to perform a call. When the user does not need to use the body part, the user can put the body part back in the holding part, and fasten or put on the holding part, thereby ensuring quality of the call, and facilitating carry for the user. The body part is a multifunctional data transmission device that can not only establish a Bluetooth communication connection with the terminal device, but also provide various monitoring functions.

### CROSS-REFERENCE

This application is a continuation of International Application No. PCT/CN2013/089385, filed on Dec. 13, 2013, which is hereby incorporated by reference in its entirety.

### TECHNICAL FIELD

The present invention relates to the communications field, and in particular, to a data transmission device and a data transmission system.

### BACKGROUND

With the popularity of terminal devices, Bluetooth apparatuses are increasingly applied to various electronic products due to their convenient and secure signal transmission manners. A Bluetooth headset is a high-tech headset product that uses a short-distance radio communications technology, which can implement wirelessness of a headset and an earphone. A Bluetooth headset can be used to perform a call, provided that a mobile phone supports a Bluetooth technology. The user can use the Bluetooth headset to answer a call when it is inconvenient for the user to hold the mobile phone, thereby avoiding an accident that may occur, for example, when the user answers a call by holding a mobile phone while driving.

Currently, a Bluetooth headset is an external component that exists independent of a mobile phone, and it is inconvenient to carry the Bluetooth headset around. The Bluetooth headset needs to be put away when a user does not need to use it. When the user needs to use the Bluetooth headset urgently, the user needs to rummage in a bag for the Bluetooth headset, but may fail to find it due to a relatively small size of the Bluetooth headset; and the Bluetooth headset may also be easily lost due to its relatively small size. In addition, the Bluetooth headset has a single function, which is limited to answering a call.

In the prior art, to solve a problem that a Bluetooth headset may be easily lost, a Bluetooth module is integrated in a watch, which, however, implements only a function of hand-free calling. During a call, there is relatively large voice interference, and privacy of a caller cannot be protected. Meanwhile, the user needs to move the watch towards the mouth during the call, and it is easy to get tired; and when it is inconvenient for the user to move the arm, quality of the call is relatively poor and even it is impossible to perform a call, resulting in extremely low user experience.

### SUMMARY

Embodiments of the present invention provide a multifunctional data transmission device and system that feature relatively good call experience and ease of carry.

According to a first aspect of the present invention, a data transmission device is provided, and includes a holding part and a body part. The holding part and the body part are connected in a movable manner; the holding part is fastened to or worn by a user; and the body part includes a Bluetooth communication module and a monitoring module, where the monitoring module is configured to perform at least one of the following operations: sports monitoring, sleep quality monitoring, environment monitoring, and physical sign monitoring, and obtain a monitoring result; and the Bluetooth communication module is configured to establish a physical Bluetooth communication connection with a terminal device.

In a first possible implementation manner, the Bluetooth communication module is a dual-channel communication module, including a Bluetooth 3.0 module and a Bluetooth 4.0 module. When receiving voice data from the terminal device, the body part establishes the Bluetooth communication connection with the terminal device by using the Bluetooth 3.0 module. When receiving non-voice data from the terminal device, the body part establishes the Bluetooth communication connection with the terminal device by using the Bluetooth 4.0 module.

According to the first possible implementation manner, in a second possible implementation manner, the Bluetooth 4.0 module includes a Bluetooth low energy BLE module. When receiving the non-voice data from the terminal device, the body part establishes the Bluetooth communication connection with the terminal device by using the BLE module.

According to the first aspect, the first possible implementation manner, or the second possible implementation manner, in a third possible implementation manner, the holding part is a wrist strap.

According to the first aspect, or the first, second, or third possible implementation manner, in a fourth possible implementation manner, a battery is disposed on the holding part, where the battery is used to supply power to the body part.

According to the fourth possible implementation manner, in a fifth possible implementation manner, one end of the holding part is a universal serial bus USB interface, where the USB interface is configured to charge the battery.

According to any one of the first aspect and the first to fifth possible implementation manners, in a sixth possible implementation manner, one end of the holding part is the universal serial bus USB interface, where the USB interface is configured to charge the body part.

According to the fifth possible implementation manner or the sixth possible implementation manner, in a seventh possible implementation manner, the USB interface is further configured to transmit communication data for establishing the Bluetooth communication connection between the Bluetooth communication module and the terminal device.

According to any one of the first aspect and the first to seventh possible implementation manners, in an eighth possible implementation manner, the data transmission device further includes a display module, where the display module is configured to display the communication data for establishing the Bluetooth communication connection between the Bluetooth communication module and the terminal device.

According to the eighth possible implementation manner, in a ninth possible implementation manner, the display module is further configured to display time.

According to any one of the first aspect and the first to ninth possible implementation manners, in a tenth possible implementation manner, the data transmission device further includes a voice notification module, where the voice notification module is configured to notify, by using a voice, the communication data for establishing the Bluetooth communication connection between the Bluetooth communication module and the terminal device.

According to the seventh, eighth, ninth, or tenth possible implementation manner, in an eleventh possible implementation manner, the communication data includes at least one of the following items: call information, incoming call notification information, an SMS message, and the monitoring result.

According to any one of the first aspect and the first to eleventh possible implementation manners, in a twelfth possible implementation manner, the holding part includes a cavity, where a movable fastener, a compressed spring, and a button used for pressing the movable fastener are disposed at one end of the cavity. One end of the body part is connected to the other end of the cavity in a movable manner; and the other end of the body part is fastened by the movable fastener, and the movable fastener retracts when the button is pressed so that the body part ejects under an action of an elastic force of the compressed spring.

According to any one of the first aspect and the first to eleventh possible implementation manners, in a thirteenth possible implementation manner, the holding part includes a clamp-shaped spring apparatus, which is configured to clamp the body part.

According to a second aspect of the present invention, a data transmission system is provided, and includes:

a data transmission device and a terminal device. The data transmission device includes a holding part and a body part. The holding part and the body part are connected in a movable manner; the holding part is fastened to or worn by a user; and the body part includes a Bluetooth communication module and a monitoring module, where the monitoring module is configured to perform at least one of the following operations: sports monitoring, sleep quality monitoring, environment monitoring, and physical sign monitoring, and obtain a monitoring result; and the Bluetooth communication module is configured to establish a physical Bluetooth communication connection with a terminal device. The terminal device is configured to establish a Bluetooth communication connection with the data transmission device.

In a first possible implementation manner, the terminal device is configured to display communication data for establishing the Bluetooth communication connection between the Bluetooth communication module and the terminal device.

According to the first possible implementation manner, in a second possible implementation manner, the communication data includes at least one of the following items: call information, incoming call notification information, an SMS message, and the monitoring result.

According to a third aspect of the present invention, a data transmission method is provided, and includes:

Establishing a physical Bluetooth communication connection with a terminal device;

acquiring a working state of the terminal device; and

determining, according to the working state of the terminal device, a mode of a Bluetooth communication connection to be established with the terminal device.

In a first possible implementation manner, Bluetooth communication connection modes include a Bluetooth 3.0 mode and a Bluetooth 4.0 mode.

According to the first possible implementation manner, in a second possible implementation manner, the establishing a physical Bluetooth communication connection with a terminal device includes: establishing the Bluetooth communication connection with the terminal device by using the Bluetooth 3.0 mode.

According to the first possible implementation manner, in a third possible implementation manner, the determining, according to the working state of the terminal device, a mode of a Bluetooth communication connection with the terminal device includes: when receiving the non-voice data from the terminal device, establishing the Bluetooth communication connection with the terminal device by using the Bluetooth 4.0 mode; and when receiving the voice data from the terminal device, establishing the Bluetooth communication connection with the terminal device by using the Bluetooth 3.0 mode.

According to the third possible implementation manner, in a fourth possible implementation manner, the Bluetooth 4.0 mode includes a Bluetooth low energy BLE mode.

According to the third possible implementation manner or the fourth possible implementation manner, in a fifth possible implementation manner, the Bluetooth 3.0 mode is turned off when the terminal device transmits the non-voice data.

It can be seen from the foregoing technical solutions that the embodiments of the present invention have the following advantages:

The embodiments of the present invention includes the following: a body part and a holding part are connected in a movable manner; the holding part is fastened to or worn by a user; the body part includes a monitoring module that is configured to perform at least one of the following operations: sports monitoring, sleep quality monitoring, environment monitoring, and physical sign monitoring, and the monitoring module may obtain a monitoring result; and the body part further includes a Bluetooth communication module that is configured to establish a physical Bluetooth communication connection with a terminal device. When a user needs to use the body part to establish a Bluetooth communication connection with the terminal device, the user may remove the body part and put it in an ear to perform a call. When the user does not need to use the body part, the user can put the body part back in the holding part, and fasten or put on the holding part, thereby ensuring quality of the call, and facilitating carry for the user. The body part is a multifunctional data transmission device that can not only establish a Bluetooth communication connection with the terminal device, but also provide various monitoring functions.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a schematic diagram of a data transmission device according to an embodiment of the present invention;

FIG. 2 is a structural diagram of a body part according to an embodiment of the present invention;

FIG. 3 is a schematic diagram of connection of a data transmission device according to an embodiment of the present invention;

FIG. 4 is a schematic diagram of connection of a data transmission device according to another embodiment of the present invention;

FIG. 5 is a schematic diagram of connection of a data transmission device according to another embodiment of the present invention;

FIG. 6 is a structural diagram of a data transmission system according to an embodiment of the present invention; and

FIG. 7 is a flowchart of a data transmission method according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person skilled in the art based on the embodiments of the present invention without creative efforts shall fall within the protection scope of the present invention.

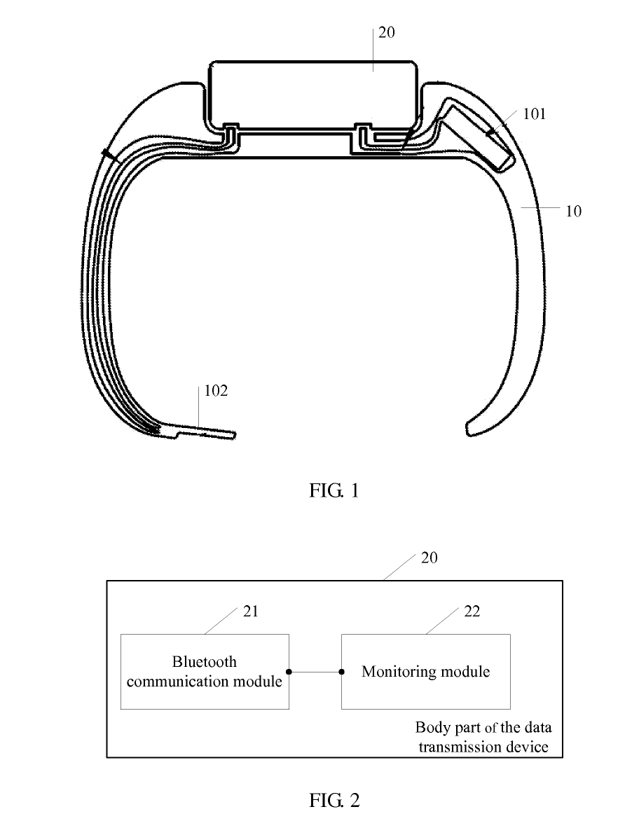

The present invention provides a multifunctional data transmission device that features relatively good call experience and ease of carry, and further provides a data transmission system, which is described in detail in the following. For details, reference may be made to FIG. 1 to FIG. 7.

### Embodiment 1

This embodiment of the present invention provides a multifunctional data transmission device that features relatively good call experience and ease of carry. FIG. 1 is a schematic diagram of the data transmission device according to this embodiment of the present invention, and FIG. 2 is a structural diagram of a body part of the data transmission device according to this embodiment of the present invention. As shown in FIG. 1 and FIG. 2, the data transmission device may specifically include:

a holding part 10 and a body part 20. The body part 20 and the holding part 10 are connected in a movable manner; the holding part 10 is fastened to or worn by a user; and the body part 20 includes a Bluetooth communication module 21 and a monitoring module 22, where the monitoring module 22 is configured to perform at least one of the following operations: sports monitoring, sleep quality monitoring, environment monitoring, and physical sign monitoring, and obtain a monitoring result; and the Bluetooth communication module 21 is configured to establish a physical Bluetooth communication connection with a terminal device.

The body part of the data transmission device in this embodiment is a multifunctional data transmission device that can not only establish a physical Bluetooth communication connection with a terminal device, but also provide various monitoring functions. The terminal device may specifically be a terminal device such as a mobile phone or a PAD.

Referring to FIG. 2, FIG. 2 is a structural diagram of the body part according to this embodiment of the present invention. The body part 20 in this embodiment includes the Bluetooth communication module 21 and the monitoring module 22. Specifically, a monitoring sensor can be integrated on a Bluetooth chip in the body part 20, so that the monitoring module 22 can perform monitoring such as sports monitoring, sleep quality monitoring, environment monitoring, and physical sign monitoring. For example, the monitoring may be specifically as follows:

sports monitoring: step counting, calorie counting, and distance counting, and so on;

sleep quality monitoring: monitoring of sleep quality;

environment monitoring: monitoring of a GPS track, an altitude, atmospheric pressure, a direction, temperature and humidity, an ultraviolet ray, and so on; and

physical sign monitoring: monitoring of a heart rate, a body temperature, an electrocardiogram, and so on.

The data transmission device in this embodiment of the present invention not only provides a Bluetooth function, but also provides the foregoing monitoring functions. For a user, possessing a data transmission device equals to possessing at a same time a Bluetooth headset, a sports bracelet, a compass, a thermometer, a pedometer, and so on, which greatly improves user experience. For example, when the user is running, the user can not only use the data transmission device to count the number of kilometers and record a track, but also put a body part of the data transmission device in an ear to perform a call, which facilitates answering the call. For example, when the user is traveling, the user may use the data transmission device to monitor an atmospheric pressure value and an altitude, and may also use the data transmission device as a compass, which adds pleasure and convenience to a journey and improves user experience.

The Bluetooth communication module 21 may establish the Bluetooth communication connection with the terminal device, which may specifically include establishing a call connection, an SMS message connection, or the like. For example, when a mobile phone is called, the Bluetooth communication module 21 can receive information about this call; and the user may directly use the body part 20 instead of the mobile phone to answer the call.

The data transmission device may further include a display module. The display module can display communication data for establishing the Bluetooth communication connection between the Bluetooth communication module and the terminal device; and the user may directly query the communication data in real time on the data transmission device. Optionally, a light emitting diode (LED, Light Emitting Diode) may be disposed on the body part. The communication data for establishing the Bluetooth communication connection between the Bluetooth communication module and the terminal device may be displayed on the LED display screen in real time for the user to view.

The display module may be integrated on the holding part of the data transmission device, or may be integrated on the body part of the data transmission device.

Optionally, the display module may also be configured to display time, and used as a watch.

The data transmission device may further include a voice notification module. The voice notification module can notify, by using a voice, the communication data for establishing the Bluetooth communication connection between the Bluetooth communication module and terminal device; and play the communication data after the Bluetooth communication module establishes the Bluetooth communication connection with the terminal device. The user can obtain the communication data by using a real-time voice of the voice notification module.

The voice notification module may be integrated on the holding part of the data transmission device, or may be integrated on the body part of the data transmission device.

The foregoing communication data for establishing the Bluetooth communication connection between the Bluetooth communication module and terminal device includes at least one of the following items: call information, incoming call notification information, an SMS message, the monitoring result obtained by the monitoring module 22, and so on.

It should be noted that, the data transmission device may send the monitoring result obtained by the monitoring module 22 to the terminal device when the Bluetooth communication module 21 establishes the Bluetooth communication connection with the terminal device. The terminal device may send a control instruction to the Bluetooth communication module 21 according to the received monitoring result, thereby switching a monitoring task. Therefore, the communication data for establishing the Bluetooth communication connection between the Bluetooth communication module 21 and the terminal device may include the monitoring result obtained by the monitoring module 22.

In addition, the data transmission device may further include a vibration motor. When the Bluetooth communication module establishes the Bluetooth communication connection with the terminal device, the data transmission device may notify a user in a vibration manner. For example, when there is an incoming call on a mobile phone, the data transmission device may vibrate to notify the user to answer the call by using the body part.

According to another embodiment of the present invention, the Bluetooth communication module 21 is a dual-channel communication module, which may specifically include a Bluetooth 3.0 module and a Bluetooth 4.0 module. When receiving voice data from the terminal device, the body part establishes the Bluetooth communication connection with the terminal device by using the Bluetooth 3.0 module. When receiving non-voice data from the terminal device, the body part establishes the Bluetooth communication connection with the terminal device by using the Bluetooth 4.0 module. When the terminal device transmits the non-voice data, the Bluetooth 3.0 module is turned off, which may effectively reduce power consumption.

According to another embodiment of the present invention, the Bluetooth 4.0 module includes a Bluetooth low energy (BLE, Bluetooth Low Energy) module. When receiving the non-voice data from the terminal device, the body part establishes the Bluetooth communication connection with the terminal device by using the BLE module in the Bluetooth 4.0 module.

The BLE module is a short-range robust radio technology that features low costs and interoperability, and works in a license exempt 2.4 GHz Industrial Scientific Medical (ISM) radio frequency band. The BLE module can reduce standby power consumption, implement a high-speed connection, and reduce peak power, which is specifically the following:

three aspects: reduction of standby power consumption, implementation of a high-speed connection, and reduction of peak power.

Reduction of standby power consumption: The Bluetooth 3.0 module uses 16 to 32 channels to perform broadcasting. However, the BLE module uses only three broadcast channels; and further, radio frequency is switched on for 0.6 to 1.2 ms each time the BLE module broadcasts. Compared with that radio frequency of the Bluetooth 3.0 module is switched on for 22.5 ms, switched-on duration of the BLE module is reduced. In addition, the BLE module sends data at more intervals than the Bluetooth 3.0 module , where the intervals are increased to 0.5 to 4 s. Therefore, radio frequency power consumption of the BLE module can almost be negligible, which effectively reduces power consumption.

Implementation of a high-speed connection: The BLE module allows a device that is performing broadcasting to be connected to a scanning device, which effectively avoids repeated scanning Completing of a process of establishing a connection with a device on which a BLE module is disposed can be controlled within 3 ms; at a same time, a linker is quickly started as an application program; and the connection is immediately disconnected after data transfer is completed within several milliseconds. For the Bluetooth 3.0 module, however, even establishing only a link at a link layer takes at least 100 ms; and time for establishing a link at a logical link control and adaptation protocol (L2CAP, Logical Link Control and Adaptation Protocol) layer is longer.

Reduction of peak power: The BLE module defines a length of a data packet more strictly, supports encapsulation of very short data (8 to 27 Byte), uses a random radio frequency parameter, and adds a Gaussian frequency-shift keying (GSFK) modulation index, which minimizes data transceiving complexity. In addition, by adding a modulation index and using a 24-bit cyclic redundancy check (CRC) code, it is ensured that the encapsulation has higher stability in case of interference, so that a radio range of the BLE module increases to over 100 m. Peak power is effectively reduced by using the foregoing techniques in combination with a frequency hopping principle of the Bluetooth 3.0 module.

FIG. 1 is a schematic diagram of the data transmission device according to this embodiment of the present invention. As shown in FIG. 1, for convenience of charging the body part, one end of the holding part 10 may be designed as a universal serial bus (USB, Universal Serial Bus) interface 102. The USB interface 102 can charge the body part 20 after the USB interface 102 is connected to a terminal such as a computer or a USB accessory, so that a user does not need to bring an extra charging device to complete charging the body part.

In addition, the data transmission device may further perform data synchronization with a terminal such as a computer via the USB interface 102. For example, communication data for establishing a Bluetooth communication connection between the Bluetooth communication module 21 and a mobile phone can be transmitted to the computer via the USB interface 102; where the communication data includes, for example, call information, incoming call notification information, an SMS message, the monitoring result obtained by the monitoring module 22, and so on. The USB interface may also transmit data, such as software, in a mobile phone to the computer, and perform an operation such as software upgrade on the mobile phone by using the computer; that is, the holding part 10 may function as a data line.

Specifically, a metal contact is disposed at a joint between the body part 20 and the holding part 10. An electrical connection between the body part and the USB interface 102 is implemented by using the metal contact.

In addition, a battery 101 may further be disposed on the holding part 10, and the battery 101 may charge the body part 20. The USB interface 102 on the holding part 10 may also charge the battery 101, so that the battery 101 has a function of a mobile power source. When a user goes traveling and cannot charge the body part, the battery 101 can be used to charge the body part 20, which improves user experience.

Optionally, the holding part 10 in this embodiment may be in a wrist strap shape or a watchband shape, which is not limited. A user may wear the data transmission device on a wrist, which facilitates use and carry; and the data transmission device is not easily lost. When the user wears the data transmission device on the wrist, the data transmission device is also decorative, thereby improving user experience.

Referring to FIG. 1, FIG. 1 is a schematic diagram of the data transmission device according to this embodiment of the present invention. The holding part 10 may hold the body part 20. The holding part 10 and the body part 20 are connected in a movable manner. A battery 101 that supplies power to the body part 20 is disposed on the holding part 10. One end of the holding part 10 is designed as the USB interface 102. The USB interface 102 may charge the body part 20. A mobile phone or the data transmission device may upload communication data to a computer via the USB interface 102, or control, such as software upgrade, of the mobile phone may be implemented via the USB interface 102.

The holding part 10 and the body part 20 of the data transmission device in this embodiment are connected in a movable manner, and the body part 20 can be connected to the holding part 10 in a pluggable manner. For example, the holding part 10 and the body part 20 can be connected by using a fastener, or be movably connected in a magnetic manner. When a user needs to use the body part 20 to perform a call, the user can remove the body part 20 and put it in an ear to make the call; and when the user does not need use the body part 20, the user can put the body part 20 back to the holding part 10, which both ensures quality of the call and facilitates carry for the user.

That the holding part 10 and the body part 20 are connected in a movable manner by using a fastener may specifically be as follows:

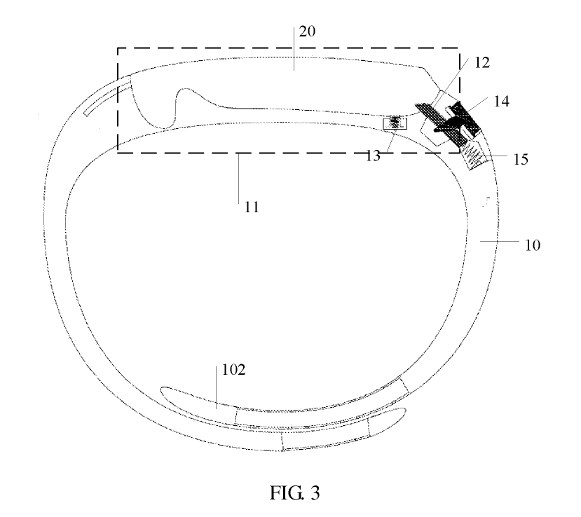

Referring to FIG. 3, FIG. 3 is a schematic diagram of connection of the data transmission device according to this embodiment of the present invention. The holding part 10 includes a cavity 11, and the body part 20 is located in the cavity 11 of the holding part 10.

A movable fastener 12, a compressed spring 13, and a button 14 used for pressing the movable fastener 12 are disposed at one end of the cavity 11. One end of the body part 20 is connected to the other end of the cavity 11 in a movable manner; and the other end of the body part 20 is fastened by the movable fastener 12, and the movable fastener 12 retracts when the button 14 is pressed so that the body part 20 ejects under an action of an elastic force of the compressed spring 13, and a user takes out the body part and put it in an ear to perform a call.

Optionally, the movable fastener 12 may be connected to the holding part 10 by using an elastic spring 15. When the button 14 is pressed down, the movable fastener 12 retracts, and the end, which is connected to the movable fastener 12, of the body part 20 ejects under the elastic force of the compressed spring 13. Then, the user can conveniently remove the body part 20 to perform a call. After the call, the user can plug in the body part 20 from a left side of the data transmission device when the data transmission device is placed in a direction shown in FIG. 3 to be held by one end of the cavity, and press the end, which is connected to the movable fastener 12, of the body part 20, so that the body part 20 and the movable fastener are fastened, and the body part 20 is placed in the cavity 11 of the holding part 10.

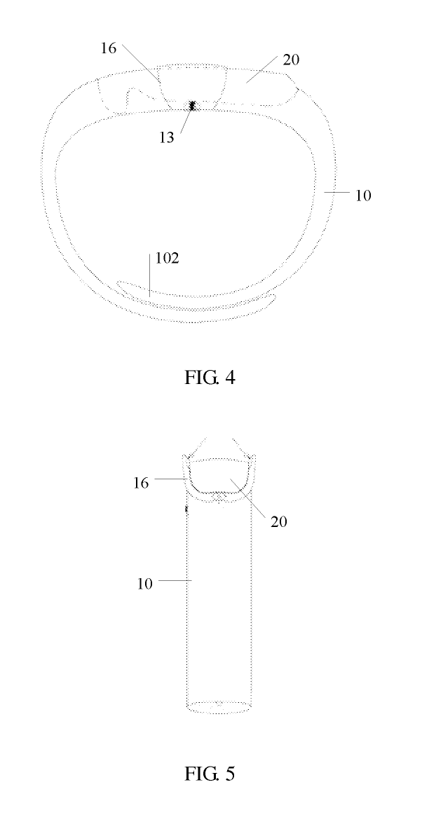

Referring to FIG. 4 or FIG. 5, FIG. 4 is a front view of the data transmission device according to another embodiment of the present invention, and FIG. 5 is a left view of the data transmission device according to the another embodiment of the present invention. The holding part 10 includes a clamp-shaped spring apparatus 16. The spring apparatus may clamp the body part 20.

In another embodiment of the present invention, the compressed spring 13 may be disposed on the holding part 10 and is used to eject the body part 20 when the spring apparatus 16 is pressed.

For a specific shape of the spring apparatus 16, reference may be made to FIG. 4 or FIG. 5. The clamp-shaped spring apparatus 16 is immovably disposed on the holding part 10. The spring apparatus 16 includes two clamping pieces; and the two clamping pieces may clamp the body part 20. When a user needs to use the body part 20, the user uses fingers to push the two clamping pieces outwards, that is, a position indicated by arrows in FIG. 5, so that the compressed spring 13 ejects the body part 20, and the user can remove the body part 20. After use, the user forcibly pushes the body part 20 back between the two clamping pieces of the spring apparatus 16, that is, the position indicated by the arrows in FIG. 5; and the body part 20 is embraced and clamped by the spring apparatus 16.

It can be known from above that the data transmission device in this embodiment of the present invention includes the following: a body part and a holding part are connected in a movable manner; the holding part is fastened to or worn by a user; the body part includes a monitoring module that is configured to perform at least one of the following operations: sports monitoring, sleep quality monitoring, environment monitoring, and physical sign monitoring, and the monitoring module may obtain a monitoring result; and the body part further includes a Bluetooth communication module that is configured to establish a physical Bluetooth communication connection with a terminal device. When a user needs to use the body part to establish a Bluetooth communication connection with the terminal device, the user may remove the body part and put it in an ear to perform a call. When the user does not need to use the body part, the user can put the body part back in the holding part, and fasten or put on the holding part, thereby ensuring quality of the call, and facilitating carry for the user. Further, the body part is a multifunctional data transmission device that can not only establish a Bluetooth communication connection with the terminal device, but also provide various monitoring functions. By monitoring a physical sign of a human body and an external environment, a personalized and customized service is provided to the user, thereby improving user experience.

### Embodiment 2

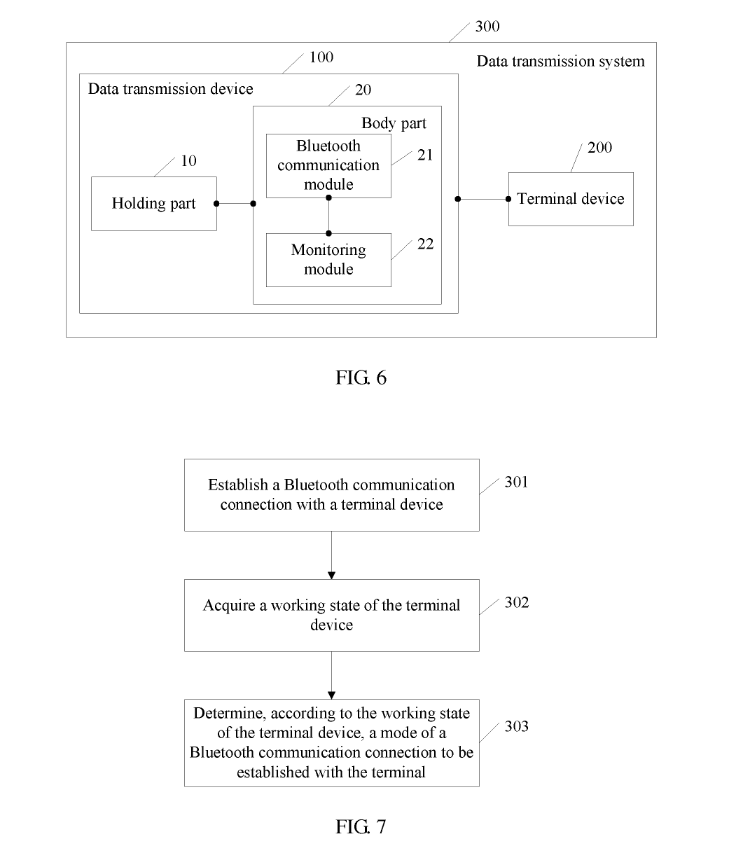

To better understand the foregoing solutions, this embodiment provides a data transmission system. FIG. 6 is a structural diagram of the data transmission system according to this embodiment of the present invention. Referring to FIG. 6, the data transmission system is specifically as follows:

A data transmission system 300 includes: a data transmission device 100 and a terminal device 200.

The data transmission device 100 includes a holding part 10 and a body part 20. The holding part 10 and the body part 20 are connected in a movable manner; the holding part 10 is fastened to or worn by a user; the body part 20 includes a Bluetooth communication module 21 and a monitoring module 22, where the monitoring module 22 is configured to perform at least one of the following operations: sports monitoring, sleep quality monitoring, environment monitoring, and physical sign monitoring, and obtain a monitoring result; and the Bluetooth communication module 21 is configured to establish a Bluetooth communication connection with the terminal device 200.

The terminal device 200 is configured to establish a Bluetooth communication connection with the data transmission device 100.

After the terminal device 200 and the Bluetooth communication module 21 are connected, the Bluetooth communication module 21 may send the monitoring result obtained by the monitoring module 22 to the terminal device 200. Therefore, communication data for establishing the Bluetooth communication connection between the terminal device 200 and the data transmission device 100 includes at least one of the following items: call information, incoming call notification information, an SMS message, and the monitoring result obtained by the monitoring module 22.

Optionally, the terminal device 200 may display the foregoing communication data for establishing the Bluetooth communication connection between the Bluetooth communication module 21 and the terminal device 200.

It should be noted that, for detailed implementation of the data transmission device 100, reference may be made to the foregoing embodiment; and details are not described herein again.

The present invention provides a data transmission system 300 that integrates a data transmission device 100 and a terminal device 200. When a user needs to perform a call, the user can remove a body part 20 in the data transmission device 100 and put it in an ear to make the call; and when the user does not need to use the body part 20, the user can put it back in the holding part 10, and fasten or put on the holding part 10, which both ensures quality of the call and facilitates carry for a user, thereby improving user experience. Further, the data transmission system 300 is a multifunctional data transmission system that also provides multiple monitoring functions. By monitoring a physical sign of a human body and an external environment, a personalized and customized service is provided to the user, thereby improving user experience.

### Embodiment 3

This embodiment further provides a data transmission method. FIG. 7 is a flowchart of the data transmission method according to this embodiment of the present invention. Referring to FIG. 7, the following steps may specifically be included:

301: Establish a physical Bluetooth communication connection with a terminal device.

302: Acquire a working state of the terminal device.

303: Determine, according to the working state of the terminal device, a mode of a Bluetooth communication connection to be established with the terminal device.

According to another embodiment of the present invention, a Bluetooth communication connection mode includes a Bluetooth 3.0 mode and a Bluetooth 4.0 mode.

Then, in step 301, establishing the Bluetooth communication connection with the terminal device specifically includes: establishing the Bluetooth communication connection with the terminal device by using the Bluetooth 3.0 mode.

Then, in step 303, determining, according to the working state of the terminal device, the mode for establishing the Bluetooth communication connection with the terminal device includes: when receiving non-voice data from the terminal device, establishing the Bluetooth communication connection with the terminal device by using the Bluetooth 4.0 mode; and when receiving voice data from the terminal device, establishing the Bluetooth communication connection with the terminal device by using the Bluetooth 3.0 mode.

It should be noted that, the Bluetooth 4.0 mode includes a Bluetooth low energy BLE mode. When the terminal device transmits the non-voice data, the Bluetooth communication connection with the terminal device is established by using the low energy BLE mode in the Bluetooth 4.0 mode.

It should be noted that, to better reduce power consumption, when the terminal device transmits the non-voice data, the Bluetooth 3.0 mode is turned off, and only the BLE mode is used to perform a communication connection with the terminal device.

Specifically, when the terminal device transmits the non-voice data, a body part establishes a Bluetooth communication connection with the terminal device by using the BLE mode. When the terminal device transmits the voice data, the Bluetooth 3.0 mode is turned on, so that the body part establishes the Bluetooth communication connection with the terminal device by using the Bluetooth 3.0 mode; after the voice data is transmitted, the Bluetooth 3.0 mode is turned off, and only the BLE mode is used to establish the communication connection, which effectively reduces power consumption.

It can be known from the above that, this embodiment provides a data transmission method, in which, a Bluetooth communication connection with a terminal device is first established; afterwards, a working state of the terminal device is acquired; and a mode of a Bluetooth communication connection to be established with the terminal device is determined according to the working state of the terminal device. Data transmission methods are flexibly switched, which reduces communication power consumption of a data transmission device and provides a better user experience to a user.

The data transmission device and the data transmission system provided by the present invention are introduced in detail in above. In this specification, specific examples are used to describe the principle and implementation manners of the present invention, and the description of the foregoing embodiments is only intended to help understand the method and core idea of the present invention. Meanwhile, a person skilled in the art may, based on the idea of the present invention, make modifications with respect to the specific implementation manners and the application scope. Therefore, the content of this specification shall not be construed as a limitation to the present invention.

1. A data transmission device, comprising:
a holding part; and
a body part; wherein
the holding part and the body part are connected in a movable manner; and the holding part is fastened to or worn by a user; and
the body part comprises a Bluetooth communication module and a monitoring module, wherein the monitoring module is configured to perform at least one of the following operations:
sports monitoring, sleep quality monitoring, environment monitoring, and physical sign monitoring, and obtain a monitoring result; and
the Bluetooth communication module is configured to establish a physical Bluetooth communication connection with a terminal device.

2. The data transmission device according to claim 1, wherein
the Bluetooth communication module is a dual-channel communication module, comprising a Bluetooth 3.0 module and a Bluetooth 4.0 module; wherein
when receiving voice data from the terminal device, the body part establishes the Bluetooth communication connection with the terminal device by using the Bluetooth 3.0 module; and
when receiving non-voice data from the terminal device, the body part establishes the Bluetooth communication connection with the terminal device by using the Bluetooth 4.0 module.

3. The data transmission device according to claim 2, wherein the Bluetooth 4.0 module comprises a Bluetooth low energy (BLE) module; and
when receiving the non-voice data from the terminal device, the body part establishes the Bluetooth communication connection with the terminal device by using the BLE module.

4. The data transmission device according to claim 1, wherein
the holding part is a wrist strap.

5. The data transmission device according to claim 1, wherein
a battery is disposed on the holding part, wherein the battery is used to supply power to the body part.

6. The data transmission device according to claim 5, wherein
one end of the holding part is a universal serial bus USB interface, wherein the USB interface is configured to charge the battery.

7. The data transmission device according to claim 1, wherein
one end of the holding part is the universal serial bus USB interface, wherein the USB interface is configured to charge the body part.

8. The data transmission device according to claim 6, wherein
the USB interface is further configured to transmit communication data for establishing the Bluetooth communication connection between the Bluetooth communication module and the terminal device.

9. The data transmission device according to claim 1, wherein the data transmission device further comprises: a display module; wherein
the display module is configured to display the communication data for establishing the Bluetooth communication connection between the Bluetooth communication module and the terminal device.

10. The data transmission device according to claim 9, wherein
the display module is further configured to display time.

11. The data transmission device according to claim 1, wherein the data transmission device further comprises: a voice notification module; wherein
the voice notification module is configured to notify, by using a voice, the communication data for establishing the Bluetooth communication connection between the Bluetooth communication module and the terminal device.

12. The data transmission device according to claim 8, wherein
the communication data comprises at least one of the following items: call information, incoming call notification information, an SMS message, and the monitoring result.

13. The data transmission device according to claim 1, wherein
the holding part comprises a cavity, wherein a movable fastener, a compressed spring, and a button used for pressing the movable fastener are disposed at one end of the cavity; and one end of the body part is connected to the other end of the cavity in a movable manner, and the other end of the body part is fastened by the movable fastener, and the movable fastener retracts when the button is pressed so that the body part ejects under an action of an elastic force of the compressed spring.

14. The data transmission device according to claim 1, wherein
the holding part comprises a clamp-shaped spring apparatus, which is configured to clamp the body part.

15. A data transmission system, comprising:
a data transmission device; and
a terminal device, wherein
the data transmission device comprises a holding part and a body part, wherein the holding part and the body part are connected in a movable manner; the holding part is fastened to or worn by a user; and the body part comprises a Bluetooth communication module and a monitoring module, wherein the monitoring module is configured to perform at least one of the following operations: sports monitoring, sleep quality monitoring, environment monitoring, and physical sign monitoring, and obtain a monitoring result; and the Bluetooth communication module is configured to establish a Bluetooth communication connection with the terminal device; and
the terminal device is configured to establish a Bluetooth communication connection with the data transmission device.

16. The data transmission system according to claim 15, wherein the terminal device is configured to display communication data for establishing the Bluetooth communication connection between the Bluetooth communication module and the terminal device.

17. The data transmission system according to claim 16, wherein the communication data comprises at least one of the following items: call information, incoming call notification information, an SMS message, and the monitoring result.
